(19) United States
(12) Patent Application Publication
(10) Pub. No.: US 2009/0277339 A1
(43) Pub. Date: Nov. 12, 2009

(54) Rotisserie grill basket for cooking small food pieces

(76) Inventor: Joseph R. Andrade, Scarsdale, NY (US)

Correspondence Address: James W. Badie, Esq., 521 Fifth Avenue, Suite 3300, New York, NY, 10175-3399, US

(21) Appl. No.: 12/151,940

(22) Filed: May 12, 2008

(51) Int. Cl. A47J 37/04

(52) U.S. Cl. 99/427; 99/449; 99/450

(57) ABSTRACT

A rotisserie is provided for cooking small pieces of food without piercing the food. The rotisserie comprises an outer generally cylindrical grill basket and an inner generally cylindrical grill basket telescoped within the outer basket. Small pieces of food such as chicken wings, meats, vegetable cuts and the like are placed in the space between the two cylindrical baskets and the rotisserie is placed in a cooking oven provided with a heating element and means for rotating the rotisserie to evenly cook the food items.

### FIELD OF THE INVENTION

The present invention relates generally to cooking apparatus and particularly to cooking apparatus which have become known commonly as rotisserie. More particularly, the present invention is related to rotisserie grill basket for use in cooking food pieces such as chicken wings, cut vegetables, fish, meats and various small size food items without piercing the food items as in the case of the whole chicken, turkey and the like.

### BACKGROUND OF THE INVENTION

Rotisserie type cooking apparatus have been known and used for a long time. One early rotisserie construction was described in U.S. Pat. No. 2,600,760 issued Jun. 17, 1953 but later various other rotisseries were developed which represent improvements in the construction of this cooking device. In the early cooking devices the meat had to be pierced during the cooking operation. In order to avoid piercing the meat, U.S. Pat. No. 4,555,986 issued Dec. 3, 1985 describes a rotisserie for cooking a variety of different types of meats including beef, pork, lamb, fowl, etc., without piercing the meat. That patent discloses a rotisserie consisting of a rotating cylinder cage and two baskets which are connected to the cage and adapted to rotate with the cage. Each basket has an open circular facing and, one having smaller diameter than the other. The two baskets are supported within the cage and can graspingly receive and hold the meat between them.

U.S. Pat. No. 6,347,577 B1 issued Feb. 19, 2002 discloses a rotisserie basket for cooking whole chicken, roasts, etc., without piercing the food with a spit or a rod. As shown in FIG. 1 of that patent the rotisserie basket consists of a pair of opposing parallel end plates secured in position by a set of parallel spaced rods. A drum shaped basket having a center axle is attached to the opposing end plate with one end of the axle having a handle mounted thereon and is longer than the opposing end of the axle which interfaces with a grill motor. The meat is held in place by a leaf spring which keeps the meat centered within the basket to ensure even heating and cooking of the meat.

A more recent patent, U.S. Pat. No. 7,241,997 B2 issued Jul. 10, 2007 describes a rotisserie oven for cooking large food items by radiant heat. The rotisserie oven comprises an interior housing defined by opposed parallel end walls, rotating members secured between the end walls for rotatably engaging the food items, and rotated by means of drive mechanism. A heating element is positioned adjacent one of said end walls and a black body radiator is placed between the rotating member and the heating element. The heating element heats the first sides of the black body radiator and the second side of the black body radiator emits radiation in a highly effective wavelength spectrum toward the food item.

The aforementioned patents and the patents referred to therein relate to and disclose various types of rotisseries primarily for cooking large meat items such as roasts, whole chicken, fowl, etc. They are not designed, nor are they well suited for cooking small food items such as chicken wings, vegetable cuts and other small food items.

It is therefore an object of the present invention to provide a cooking apparatus designed for heating and cooking small food items such as chicken wings, fish, fowl, cut vegetables, smaller cut meats and the like small food items.

It is a further object of the present invention to provide a rotisserie for cooking small food items evenly and effectively without the need for piercing the food by spits or rods as is customary in cooking large food items.

It is also an object of the present invention to provide a rotisserie comprising outer cylindrical basket and an inner cylindrical basket wherein the food bits are wedged in between the two baskets and cooked by heating as the rotisserie is rotated by a drive means, without the need to pierce the food items by spits, rods or the like.

### SUMMARY OF THE INVENTION

In accordance with this invention, a rotisserie is provided which is uniquely designed for cooking small pieces of food items such as chicken wings, meat, fish, fowl and vegetable cuts without piercing the food. The rotisserie comprises an outer generally cylindrical basket, a smaller, inner generally cylindrical basket which is telescoped within the outer basket. The small food items to be cooked are placed in the space between the inner basket and outer basket and are retained in position by being grasped between the cylinders during cooking.

The outer basket has an open end and an opposed end plate. The end plate has an inner surface having a centrally disposed seat structure projecting from the middle of the inside surface. The inner basket has an open end and an opposed end plate. The open end is adapted to be secured to the seat structure on the inside surface of the end plate of said outer cylindrical basket when the inner cylindrical basket is telescoped within the outer cylindrical basket.

The rotisserie assembly can be placed in a cooking oven provided with a heating element for heating the meat in the rotisserie as the rotisserie is rotated within the cooking oven.

### BRIEF DESCRIPTION OF THE DRAWINGS

In the drawings wherein like reference numerals are employed to designated like parts:

FIG. 1 is a perspective view of the rotisserie of the present invention in assembled position, with an outer generally cylindrical basket and an inner generally cylindrical basket, showing small pieces of food items wedged in the space between the two cylindrical baskets;

FIG. 2 is a top plan view of the outer cylindrical basket in open, non-assembled position with attached end plate;

FIG. 3 is a perspective view of the inner cylindrical basket with one end affixed to an end plate and an opposite end adapted to be telescoped within the outer basket;

FIG. 4 is an exploded view, partly perspective of the outer basket as shown in FIG. 2, and the inner basket in position for telescoping within the outer basket, with the small food items placed for cooking;

FIG. 5 is a top view of the rotisserie shown in FIG. 1;

FIG. 6 is a side view of the rotisserie shown in FIG. 5;

FIG. 7 is a top view of the rotisserie, in assembled position, placed in a cooking oven for cooking the food items placed between the inner and outer cylindrical baskets;

FIG. 8 is a side view taken along the line 8-8 in FIG. 7; and

FIG. 9 is a top view showing, in isolation, the outer cylindrical basket and the inner cylindrical basket, and a spit with a drive means for rotating the rotisserie assembly while heating in a cooking oven.

### DETAILED DESCRIPTION OF THE INVENTION

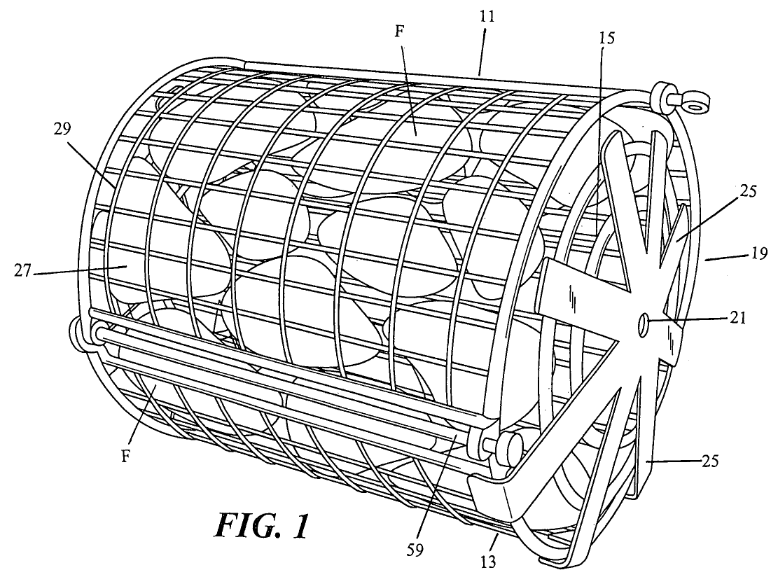

Referring first to FIGS. 1-4 of the drawings, the rotisserie in assembled position is generally designated by the reference numeral 11 comprising an outer generally cylindrical grill basket 13 and an inner generally cylindrical grill basket 15. Each of these cylindrical baskets is a separate unit designed so that the inner cylindrical basket 15 is telescoped within the outer cylindrical basket 13 and is rigidly secured thereon as hereinafter described.

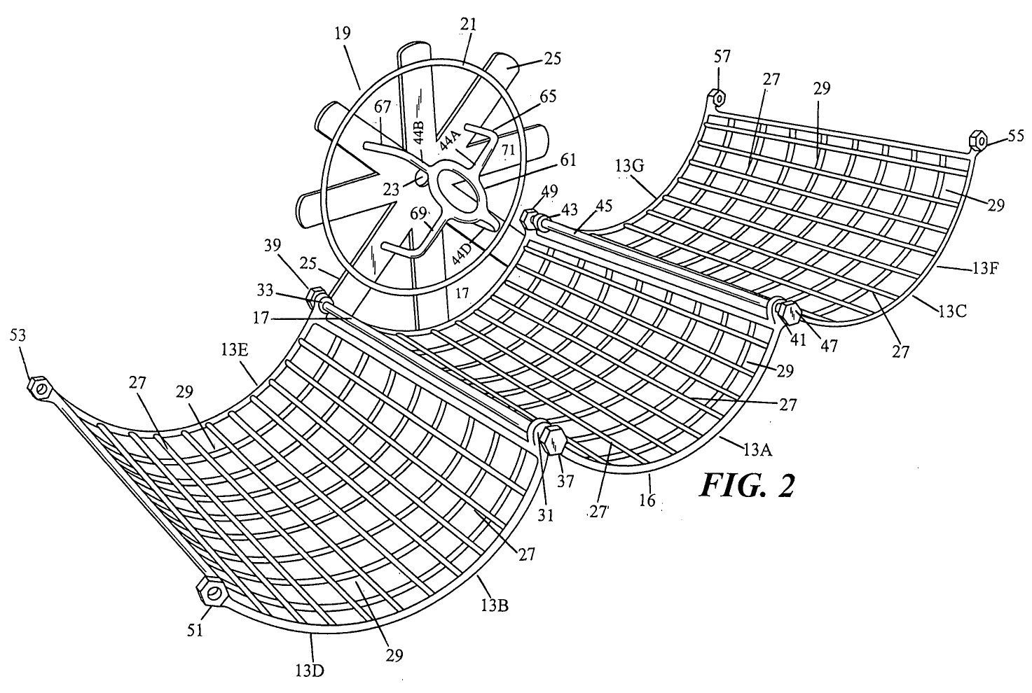

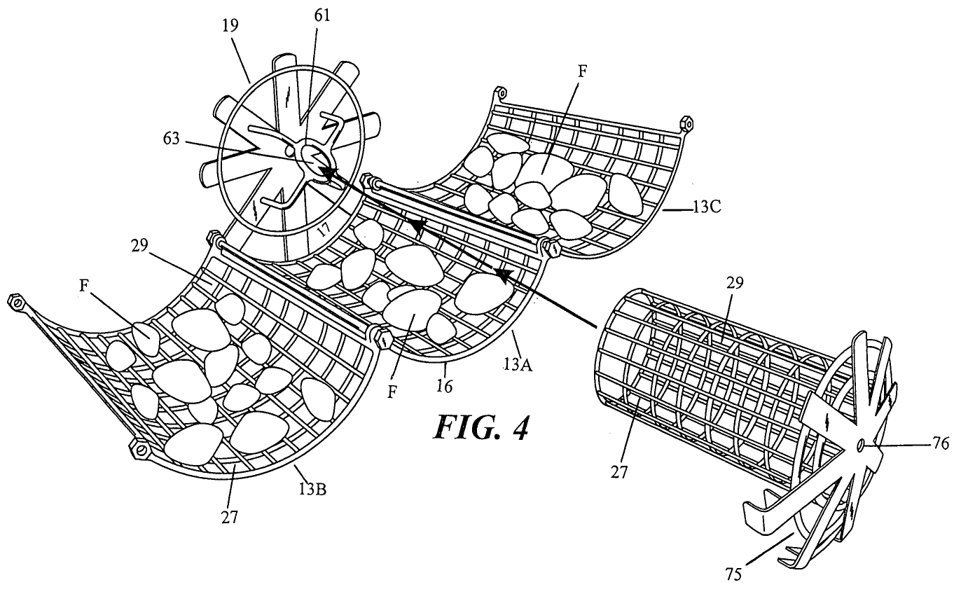

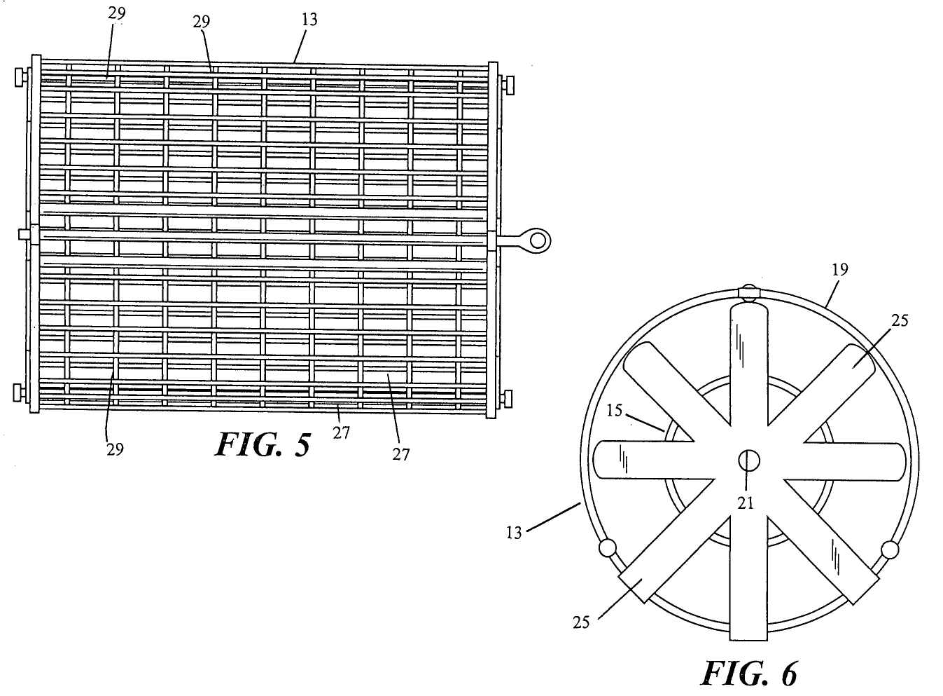

The outer cylindrical basket 13 is formed in three sections, a fixed middle section 13A and rotatable side sections 13B and 13C. The fixed middle section 13A is defined by opposed, generally parallel lateral edges 16 and 17 with the edge 17 being secured to an end plate 19 formed from a circular member 21 having a central aperture 23 and a plurality (e.g., 8) radially spaced ribs 25 which are secured to the circular member 21, such as by welding as shown in FIGS. 2 and 4.

The fixed section 13A as well as the side sections 13B and 13C of the outer basket 13 are formed from a plurality of generally parallel longitudinal and preferably equidistantly spaced metallic or semi-rigid rods or wires 27 and a plurality of similar but generally lateral and equidistantly spaced cross rods or wires 29. As shown in Figures 2 and 4, the side section 13B and the mid section 13A are hingedly connected at their respective adjacent longitudinal ends and, similarly, the side sections 13C and 13A are hingedly connected at their respective adjacent longitudinal ends. Thus, the opposed lateral ends 13D, 13E of the side section 13B are provided with the integral nuts 31, 33 secured at each end and adapted for the passage therethrough of an elongated rod 35 capped at each end by the solid caps 37,39. Thus, the side section 13B is rotatable about the elongated rod 35 to define one-third of the outer basket. Similarly, the opposed lateral ends 13F, 13G are provided with integral nuts 41, 43 through which is passed an elongated rod 45 capped at each end by the solid caps 47, 49. The side section 13C is thus rotatable about the elongated rod 45 to form another third portion of the outer basket.

The side sections 13B and 13C are provided at their outer longitudinal ends with the integral nuts 51, 53, 55 and 57 which have the same eye or opening as the nuts 31, 33, 41, 43. Thus when the rotatable basket sections 13B and 13C are rotated about their longitudinal axis about the end plate 19, the openings of nuts 51 and 55 will be aligned with each other, and similarly the openings in nuts 53 and 57 will be aligned with each other as well as aligned with the openings in nuts 51, 53. A fixing rod 59 is passed through said openings to securely form the outer basket.

As shown in FIGS. 2 and 4, the end plate 19 is provided at its inner surface, attached to the ribs, a seat structure 61 having a generally oval shaped central seat structure 63 with four anchors 65, 67, 69, 71 each welded to a rib of the plate 19. The seat structure 61 is adapted to securely engage the open end of the inner basket 15 as hereinafter described.

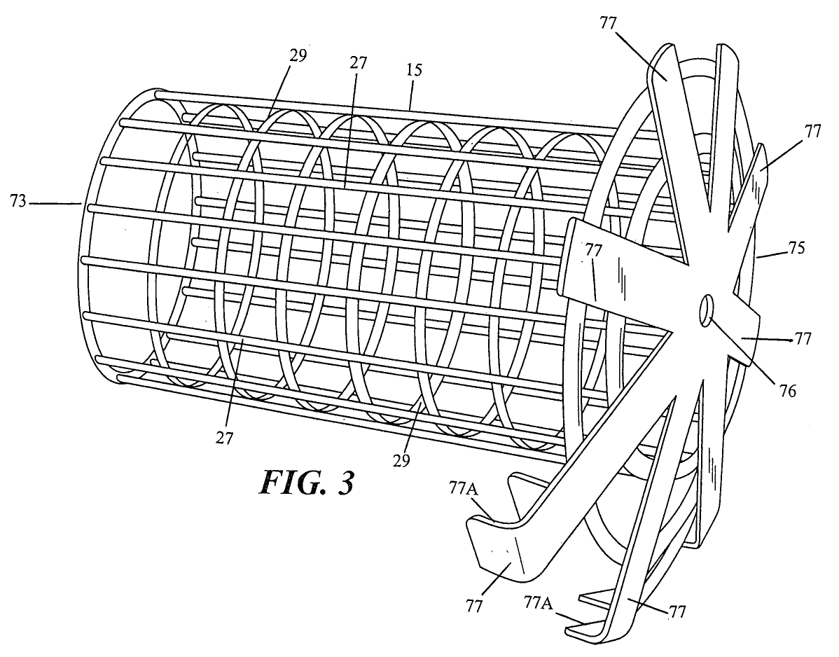

Referring to FIGS. 3 and 4, the inner basket 15 comprises an open circular member at one end 73 and an opposed end plate 75 at the other end. The end plate 75 has an outer surface to which is fixed, as by welding, several (e.g., 8) lateral metallic ribs 73. Several of the ribs 77 are formed with grip ends such as 77A so that when the inner basket is fully inserted into the outer basket the grip ends 77A will lockingly grip the seat member 63 of the outer basket. The end plate 75 of the inner basket has a central aperture 76 which, when the inner basket is inserted into the outer basket to form the rotisserie assembly the aperture 21 of the end plate 19 and the aperture 76 of the inner basket will be in axial alignment.

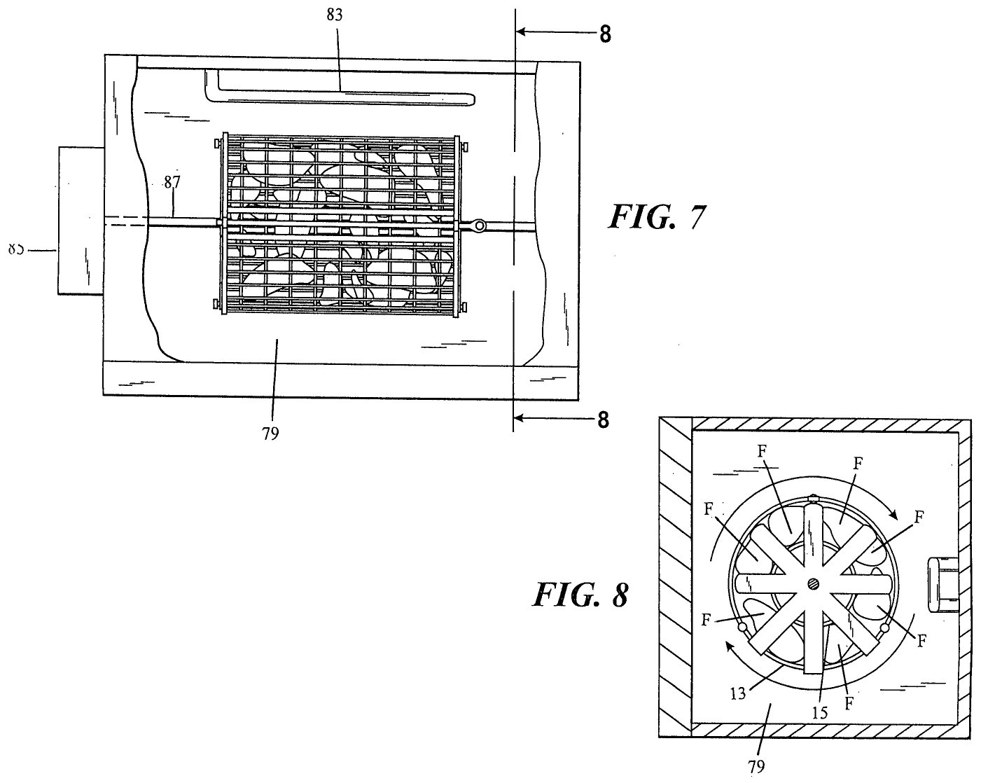

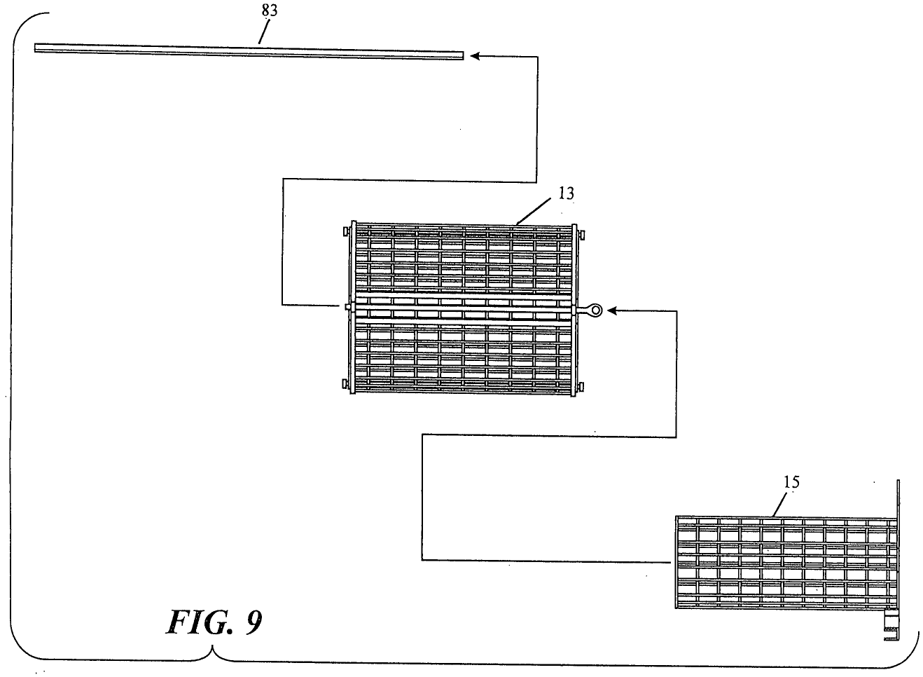

As shown in FIG. 4, the meat pieces are placed on the inside surfaces of sections 13A, 13B and 13C of the outer basket and, after the inner basket is inserted through the outer basket and the rotisserie is assembled as hereinbelow described, the food pieces will be wedged in the space between the cylindrical baskets (see FIGS. 1 and 7). The assembled rotisserie 11 is then placed in a cooking oven 79 attached to a drive motor 83 as shown in FIG. 7. Also disposed in the cooking oven 79 above the rotisserie assembly is a heating element 85 which can be heated by an external electrical heating source (not shown). An elongated rod (spit) 87 is passed through the apertures 21 and 26 which are in alignment with each other, and is connected to the drive motor 83. When the motor 83 is activated, the rod 87 will rotate thus causing the rotisserie to rotate and expose the meat pieces to heat from the heating element. The motor 83 may conveniently be a variable speed motor in order to change the speed of rotation of the elongated rod 87 and thus vary the speed of rotation of the rotisserie assembly. When the meat pieces are cooked to the desired degree, the motor is shut off, the heating is discontinued and the meat pieces are removed for consumption.

While in the foregoing detailed description of the invention the rotisserie assembly has been described with certain degree of particularity, it can be appreciated that changes may be made therein which are suggested from the present description. Such changes include the type of oven used for cooking, the heating mode or element used to heat the food and the drive means employed to rotate the rotisserie in the oven. Also, the outer and inner rotisserie baskets need not necessarily be cylindrical, although cylindrical construction is preferable. The outer and inner cylinders may be conveniently sized so that the space between them is adequate to permit the food items to be graspingly engaged or wedged therein without falling during the cooking cycle. The foregoing and other changes or modifications are obvious to those skilled in the art and are nevertheless suggested from the description herein.

1. A rotisserie for cooking small pieces of food such as meat, fish, fowl and vegetable cuts without piercing the food, which comprises:
an outer generally cylindrical basket having an open end and an opposed end plate having an outer surface and an inner surface, said inner surface having a seat structure projecting from the middle thereof,
an inner generally cylindrical basket having opposed ends, an open end adapted to be secured to said seat structure when said inner cylindrical basket is telescoped within said outer cylindrical basket, an end plate at the opposed end,
a space defined between the outer cylindrical basket and said inner cylindrical basket for placing said food,
cooking oven for placing said rotisserie therein, and
drive means for rotating said rotisserie in said cooking oven.

2. A rotisserie as in claim 1 wherein said end plate of said outer cylindrical basket has a central aperture and said end plate of said inner cylindrical basket has a central aperture in axial alignment with the aperture in the end plate of said outer cylindrical basket, and a spit inserted through said aperture and projecting beyond said end plate adapted to be engaged and driven by said drive means.

3. A rotisserie as in claim 1 wherein said outer cylindrical basket comprises three sections, a fixed middle section and an outer section on each side of said middle section, each of said side sections being hingedly connected to an adjacent side of said middle section and being rotatable thereabout to form said outer cylindrical basket.

4. A rotisserie as in claim 2 wherein said outer cylindrical basket comprises three sections, a fixed middle section and an outer section on each side of said middle section, each of said side sections being hingedly connected to an adjacent side of said middle section and being rotatable thereabout to form said outer cylindrical basket.

5. A rotisserie as in claim 3 wherein said inner cylindrical basket has opposed ends, an open end adapted to be secured to said seat structure of the end plate of said outer cylindrical basket when said inner cylindrical basket is telescoped within said outer cylindrical basket.

6. A rotisserie as in claim 4 wherein said inner cylindrical basket has opposed ends, an open end adapted to be secured to said seat structure of the end plate of said outer cylindrical basket when said inner cylindrical basket is telescoped within said outer cylindrical basket.

7. A rotisserie as in claim 1 wherein each of said cylindrical baskets is formed from a plurality of axial, generally parallel spaced metal wires and a plurality of generally parallel spaced metallic cross wires.

8. A rotisserie as in claim 2 wherein each of said cylindrical baskets is formed from a plurality of axial, generally parallel spaced metal wires and a plurality of generally parallel spaced metallic cross wires.

9. A rotisserie as in claim 3 wherein each of said cylindrical baskets is formed from a plurality of axial, generally parallel spaced metal wires and a plurality of generally parallel spaced metallic cross wires.

10. A rotisserie as in claim 4 wherein each of said cylindrical baskets is formed from a plurality of axial, generally parallel spaced metal wires and a plurality of generally parallel spaced metallic cross wires.

11. A rotisserie as in claim 5 wherein each of said cylindrical baskets is formed from a plurality of axial, generally parallel spaced metal wires and a plurality of generally parallel spaced metallic cross wires.

12. A rotisserie as in claim 6 wherein each of said cylindrical baskets is formed from a plurality of axial, generally parallel spaced metal wires and a plurality of generally parallel spaced metallic cross wires.
